(19) United States
(12) Patent Application Publication
(10) Pub. No.: US 2004/0069700 A1
(43) Pub. Date: Apr. 15, 2004

(54) Fuel filter assembly, and a method of changing a fuel filter within a fuel system

(76) Inventors: Terry L. Miller, Morton, IL (US); C. Brian Myer, Peoria, IL (US); Paul A. Gamble, Peoria, IL (US)

Correspondence Address: Michael B. McNeil, Liell & McNeil Attorneys PC, P.O. Box 2417, Bloomington, IN, 47402, US

(21) Appl. No.: 10/267,493

(22) Filed: Oct. 9, 2002

(51) Int. Cl. B01D 27/00

(52) U.S. Cl. 210/235

(57) ABSTRACT

In order to change a fuel filter within a fuel system, a fuel filter assembly in which the fuel filter is positioned is generally detached from the fuel system, allowing fuel to drain from and debris to enter the fuel system. The present invention reduces the draining of fuel from and the entering of debris in a fuel system by blocking, at least in part, fluid communication between the fuel system and the environment when the fuel filter assembly is detached from the fuel system. A valve is positioned within a fuel passage of the fuel system, and a valve engaging member is attached to a fuel filter assembly. The valve is closed, at least in part, by detaching the fuel filter assembly from the fuel system. When the fuel filter assembly is detached from the fuel system, the valve engaging member is out of contact with the valve. The valve is opened, at least in part, by attaching the fuel filter assembly to the fuel system. When the fuel filter assembly is attached to the fuel system, the valve engaging member is in contact with the valve.

### TECHNICAL FIELD

The present invention relates generally to fuel filter assemblies within fuel systems, and more specifically to a method of changing a fuel filter within the fuel filter assembly.

### BACKGROUND

In several fuel systems today, fuel filter assemblies conduct intense filtering of the fuel before the fuel is injected in an engine. When fuel is passed through a fuel filter positioned within the fuel filter assembly, water is separated from the fuel, and particulates and other solids are removed from the fuel. Typically, a fuel pump will pump the fuel from a fuel storage tank to the engine via a fuel passage. At least one fuel filter assembly is positioned within the fuel passage such that the fuel can pass through the fuel filter(s) prior to being injected into the engine. Over time, the separated particulates and other solids attached to the fuel filter may affect the performance of the fuel filter. From time to time, the fuel filter should be removed from the fuel system and replaced with a new fuel filter. Thus, fuel filter assemblies should be designed to be detachable from the fuel system with relative ease, and to minimize the effect of changing the fuel filter on the rest of the fuel system. For example, fuel filter assemblies, such as that shown in U.S. Pat. No. 6,090,208, issued to Connelly, et at. on Aug. 1, 2000, are designed to be threadibly mated, and sealed, to the fuel system each time the fuel filter assembly is attached to the fuel system. The seal prevents leakage between the detachable fuel filter assembly and the fuel passage.

Although there are methods of changing the fuel filter without significantly disrupting the fuel system, there is room for improvement. For instance, when the engine, and thus the fuel system, is de-activated, fuel that was being circulated through the fuel system will remain within the fuel passage, a portion of which extends through the fuel filter assembly. When the fuel filter assembly is removed in order to change the fuel filter, the fuel passage is open to the environment, allowing some of the remaining fuel to drain from the fuel system, causing waste and likely a mess that must be cleaned up. In addition, if fuel is drained from the fuel system, the entire fuel system, rather than just the fresh fuel filter, may need to be re-primed with fuel in order to operate the engine without damaging other components within the fuel system. For instance, the fuel system may include a second fuel filter assembly positioned adjacent to the first filter and in communication with the first filter assembly. If fuel is drained from the fuel system through the open fuel passage, air may replace the space within the fuel passage that was occupied by the drained fuel. If air, rather than fuel, is supplied to the second fuel filter, downstream components, such as fuel injectors, may be damaged.

In addition, there are situations in which it may be necessary to maintain the filter assembly detached from the fuel system for an extended period of time. Because removing the fuel filter will expose the fuel passage to the environment, debris may enter the fuel system. The debris may cause other components within the fuel system, such as the fuel pump, to malfunction.

The present invention is directed to overcoming one or more of the problems set forth above.

### SUMMARY OF THE INVENTION

In one aspect of the present invention, a fuel filter assembly includes a fuel filter positioned within a housing. At least one of the fuel filter and the housing defines a fuel passage in which at least one valve engaging member is positioned.

In another aspect of the present invention, a fuel system includes a fuel passage including a filter portion and a delivery portion. A detachable fuel filter assembly to which a valve engaging member is attached defines the filter portion of the fuel passage. A valve that is moveable between an open position and a closed position is positioned within the delivery portion of the fuel passage.

When the fuel filter assembly is attached to the fuel system, the valve engaging member is in contact with the valve. When the fuel filter assembly is detached from the fuel system, the valve engaging member is out of contact with the valve.

In yet another aspect of the present invention, there is a method of changing a fuel filter within a fuel system. A valve that is positioned within the fuel system is closed, at least in part, by detaching a fuel filter assembly from the fuel system. The valve is opened, at least in part, by attaching the fuel filter assembly to the fuel system.

### BRIEF DESCRIPTION OF THE DRAWINGS

FIG. 1 is a schematic representation of a fuel system, according to the present invention;

FIG. 2 is a sectioned side view of a pair of fuel filter assemblies included within the fuel system of FIG. 1; and

FIG. 3 is a sectioned side view of a valve positioned within a fuel passage included in the fuel system of FIG. 1.

### DETAILED DESCRIPTION

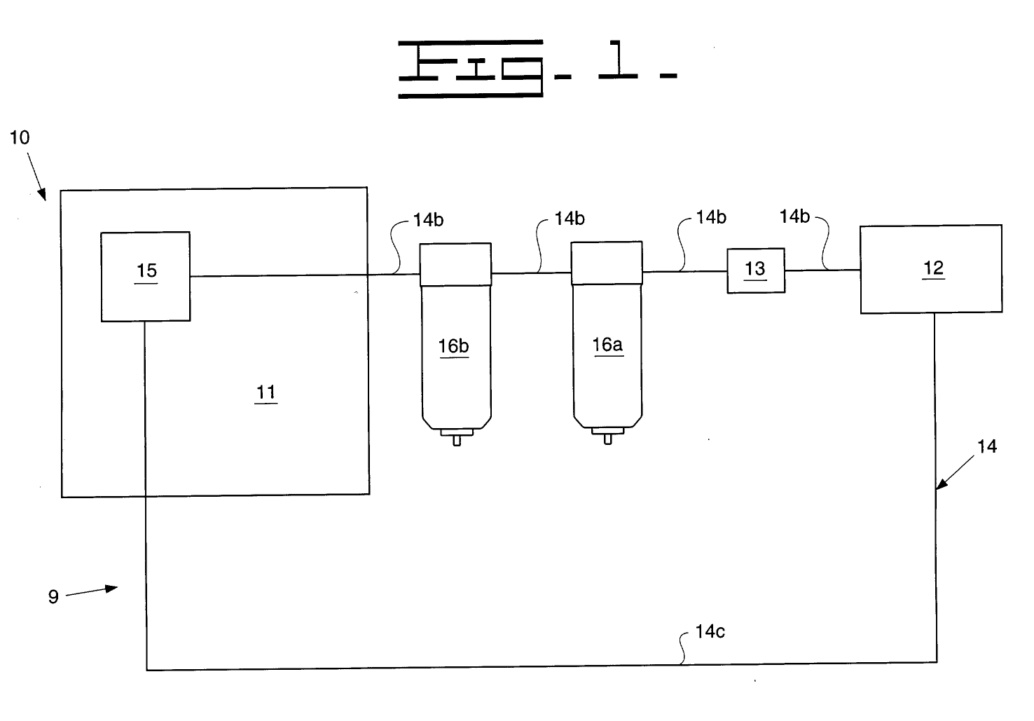

Referring to FIG. 1, there is shown a schematic representation of a fuel system 9, according to the present invention. An engine 10 comprises an engine housing 11 to which the fuel system 9 is attached. The fuel system 9 includes a fuel passage 14 in which fuel is circulated between a fuel tank 12 and the engine 10. A fuel transfer pump 13 draws low pressure fuel out of the fuel tank 12 to circulate the fuel through the fuel system 9. The fuel flows from the fuel transfer pump 13 to a first fuel filter assembly 16a and a second fuel filter assembly 16b via a delivery portion 14b of the fuel passage 14. It should be appreciated that although the fuel transfer pump 13 is illustrated as separate from the fuel filter assemblies 16a and 16b, the fuel transfer pump 13 could be attached to, or contained in the same housing as, at least one of the fuel filter assemblies 16a and 16b.

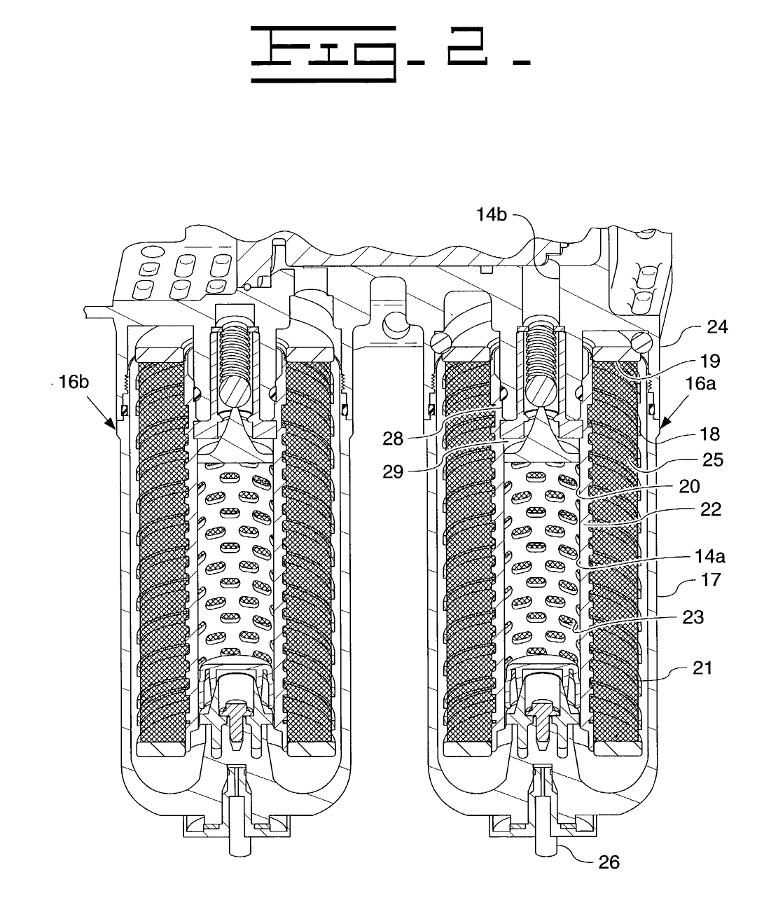

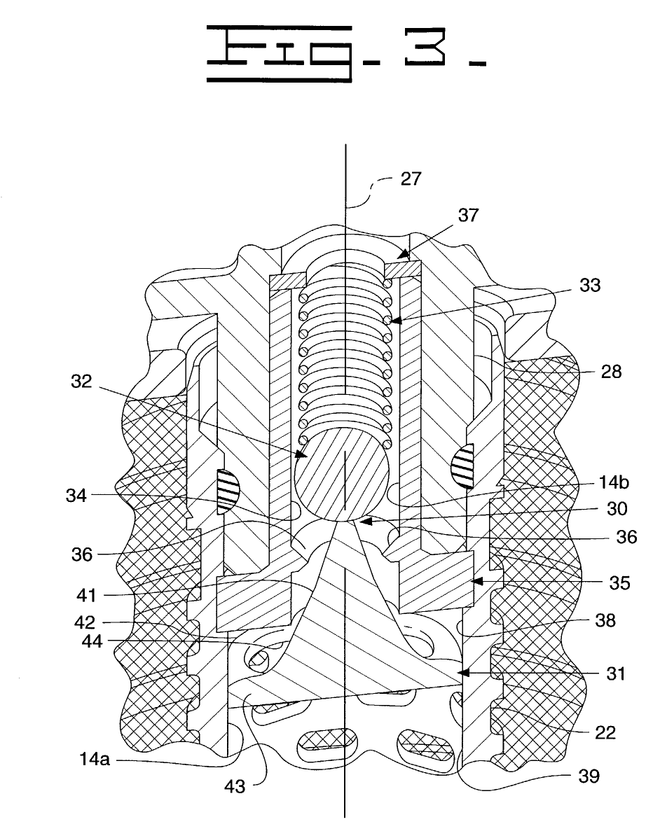

The fuel passage 14 also includes a filter portion 14a (shown in FIGS. 2 and 3) that is defined by the first fuel filter assembly 16a and the second fuel filter assembly 16b. It should be appreciated that the fuel filter assemblies 16a and 16b may be attached to the engine housing 11 or the body of the vehicle or machinery. The fuel flows through the first fuel filter assembly 16a, and then through the second fuel filter assembly 16b. As the fuel flows through the fuel filter assemblies 16a and 16b, the fuel filter assemblies 16a and 16b act to trap precipitates and other solids from fuel flowing through the fuel system 9, and to separate water from the fuel. Although the present invention is illustrated as including two fuel filter assemblies 16a and 16b, it should be appreciated that the present invention contemplates a fuel system with any number of fuel filter assemblies, including only one. Further, it should be appreciated that both fuel filter assemblies 16a and 16b operate similarly, except that one of the fuel filter assemblies 16a and 16b includes a suctioned fuel filter and the other fuel filter assembly 16a or 16b includes a pressure fuel filter. Those skilled in the art will appreciate that the suctioned fuel filter pulls fuel through the fuel filter, and the pressure fuel filter pushes fuel through the fuel filter. After the fuel is cleaned by the fuel filter assemblies 16a and 16b, the fuel is delivered via the delivery portion 14b of the fuel passage 14 to at least one fuel injector 15 provided within the engine 10. While the present invention is described for one fuel injector 15, it should be appreciated the present invention is applicable to an engine housing any desired number of fuel injectors. The fuel not injected into the engine 9 by the fuel injector 15 will be returned to the fuel tank 12 via a return portion 14c of the fuel passage 14 to be re-circulated throughout the fuel system 9.

Referring to FIG. 2, there is shown a sectioned side view of the fuel filter assemblies 16a and 16b of the fuel system 9 of FIG. 1. Although the present invention will be discussed for only the first fuel filter assembly 16a, it should be appreciated that the present invention operates similarly in both fuel filter assemblies 16a and 16b. The fuel filter assembly 16a is illustrated as attached and secured to a filter head 24 via a threaded portion of either the fuel filter assembly 16a or the filter head 24. It should be appreciated that the threaded portion may be included at various points of the fuel filter assembly 16a and the filter head 24, such as an outer surface of a center extension 28 of the filter head 24. The fuel filter assembly 16a is illustrated as an inverted-type filter in which the fuel filter assembly 16a is suspended generally below the filter head 24. Those skilled in the art will appreciate that the fuel filter assembly 16a and the filter head 24 may be positioned in various other angular orientations defined by the dimensional constraints. A fuel filter 18 is positioned inside a housing 17 of the fuel filter assembly 16a. The fuel filter 18 is disposable, and can be removed from the housing 17 and replaced for maintenance purposes. Although the present invention is illustrated for the fuel filter 18 that is separable from the housing 17, the present invention may also be utilized with a fuel filter that is attached to the housing 17 and is replaced along with the housing 17.

The fuel filter 18 includes a cylindrical core 22 preferably comprised of a plastic material, and a filter element 21 comprised of a medium that is suitable for separating contaminants. The cylindrical core 22 defines a center passage 20 of the filter portion 14b of the fuel passage 14. However, it should be appreciated that the center passage 20 could be defined, at least in part, by the housing 17. The filter element 21 defines an outer peripheral passage 25 also included in the filter portion 14b of the fuel passage 14. The outer peripheral passage 25 includes an inlet 19 of the fuel filter 18, and the center passage 20 includes an outlet 29 of the fuel filter 18. The outer peripheral passage 25 is in fluid communication with the delivery portion 14b via the inlet 19, and the center passage 20 is in fluid communication with the deliver portion 14b via the outlet 29. The cylindrical core 22 includes a plurality of holes 23 that fluidly connect the outer peripheral passage 25 with the center passage 20.

The arrows in FIG. 2 demonstrate the flow of fuel from the delivery portion 14b of the fuel passage 14 to the filter portion 14a of the fuel passage 14 via the inlet 19. As the fuel flows through the filter element 21, particulates and other solids are removed from the fuel, and water is separated from the fuel. The cleaned fuel flows to the center passage 20 via the plurality of holes 23 defined by the cylindrical core 22. A valve 30 is positioned within the fuel passage 14. When the valve 30 is open (as illustrated in FIG. 2), the fuel can then flow back to the delivery portion 14b via the outlet 29. The fuel will flow through the second fuel filter assembly 16b in a similar manner. It should be appreciated that the present invention contemplates a fuel system in which the fuel enters a fuel filter via a center passage and exits the fuel filter via an outer peripheral passage. Thus, the fuel could flow outwardly across a filter element. Further, the present invention contemplates a fuel system in which the fuel flows from right to left through the fuel filter assemblies. Due to its specific gravity, the separated water collects in the bottom cupped-shaped area of the housing 17. A water drain valve 26 is attached to the lower portion of the housing 17. In order to dispose of the collected water and to drain the water from the housing 17, the water drain valve 26 may be manually opened. Although the preferred embodiments include the water drain valve 26, other means of removing the collected water from the fuel filter assembly 16a can be used, including but not limited to, a removable collection bowl attached at the lowest point of the housing 17.

Referring to FIG. 3, there is shown a sectioned side view of the valve 30 and a valve engaging member 31 positioned within the fuel passage 14 included in the fuel system 9 of FIG. 1. The valve 30 is positioned in the delivery portion 14b of the fuel passage 14. Although the valve 30 could be of varying types and sizes, the valve 30 is preferably a check ball valve. The valve includes a valve member, being a ball valve member 32 biased to a closed position by a spring 33. The ball valve member 32, the spring 33, and a washer 37 positioned above the spring 33, are included within a valve bore 34 defined by a spacer 35. The spacer 35 is attached to an inner surface of the center extension 28 of the filter head 24 and includes a valve seat 36. The check ball valve 30 is moveable between a closed position and an open position. When the check ball valve 30 is in the closed position, the ball valve member 32 is in contact with the valve seat 36 under the bias of the spring 33. When the check ball valve 30 is in the open position, the ball valve member 32 is out of contact with the valve seat 36 (as shown in FIG. 3).

Referring still to FIG. 3, the valve engaging member 31 is attached to the fuel filter assembly 16a. Although the valve engaging member 31 is illustrated as positioned within the filter portion 14b of the fuel passage 14, it should be appreciated that the valve engaging member 31 could be attached at any point on the fuel filter assembly 16a at which the valve engaging member 31 can make contact with the valve 30. For instance, the present invention contemplates the filter head 24 without the center extension 28, and the valve engaging member 31 being attached to the fuel filter assembly 16a directly above the filter portion 14a in order to make contact with the valve 30. However, the valve engaging member 31 preferably separates an upstream portion 38 and downstream portion 39 of the filter portion 14b of the fuel passage 14. A centerline 27 of the housing 17 preferably intersects the valve engaging member 31. Further, the valve engaging member 31 and the cylindrical core 22 are preferably integrally molded from the plastic material comprising the cylindrical core 22. However, it should be appreciated that the valve engaging member 31 could be attached to the cylindrical core 22 by various means known in the art. Although the valve engaging member 31 could be various shapes, the valve engaging member 31 preferably includes a tapered punch 41 and a ring 42. The tapered punch 41 is attached to the ring 42 via a plurality of arms 43, and the ring 42 defines a ring portion 44 of filter portion 14a of the fuel passage 14.

When the fuel filter assembly 16a is attached to the fuel system 9, the tapered punch 41 of the valve engaging member 31 is in contact with the check ball valve member 32. The check ball valve member 32 lifts off the valve seat 36, and the check ball valve 30 moves to the open position (as shown in FIG. 3), fluidly connecting the filter portion 14a with the delivery portion 14b of the fuel passage 14. When the fuel filter assembly 16 is detached from the fuel system 9, the tapered punch 41 of the valve engaging member 31 is out of contact with the ball valve member 32 and the ball valve member 32 rests on the valve seat 36 under the bias of the spring 33. The valve 30 is in its closed position closing fuel passage 14.

### Industrial Applicability

Referring to FIGS. 1-3, the operation of the present invention will be described for the first fuel filter assembly 16a, although it should be appreciated that the present invention operates similarly in the first and second fuel filter assemblies 16a and 16b. Thus, the present invention may operate in fuel filter assemblies including various types of fuel filters, including but not limited to, the suctioned fuel filter and the pressure fuel filter included in the fuel filter assemblies 16a and 16b. Moreover, the present invention is applicable to various fuel filter assemblies, regardless of the direction of the fuel flow through the fuel filter.

After prolonged use of the fuel filter 18, the fuel filter 18 will become dirty and may not function as well as a new fuel filter. Therefore, periodically, the fuel filter 18 must be changed. Prior to changing the fuel filter 18, the engine 10 of the vehicle or machinery will be de-activated. Thus, the fuel transfer pump 13 will be inactive, and will not be pumping fuel from the fuel tank 12 through the fuel system 9. Fuel that was within the fuel passage 14 when the engine 10 was de-activated may remain within the fuel passage 14. Because the fuel filter assembly 16a is attached to the fuel system 9, the valve engaging member 31 is in contact with the ball valve member 32. The ball valve member 32 will be out of contact with the valve seat 36, and the check ball valve 30 will be open. The center passage 20 of the fuel filter 18 will be fluidly connected to the delivery portion 14b of the fuel passage 14.

In order to change the fuel filter 18, the fuel filter assembly 16a will be manually detached from the fuel system 9. In order to detach the fuel filter assembly 16a, the housing 17 in which the fuel filter 18 is positioned will be rotated. As the housing 17 is rotated, the valve engaging member 31 will move out of contact with the ball valve member 32. The ball valve member 32 will move under the bias of the spring 33 until it makes contact with the valve seat 36. Once the ball valve member 32 is in contact with the valve seat 36, the check ball valve 32 will be in the closed position, blocking fluid communication between the delivery portion 14b of the fuel passage 14 and the center passage 20 of the fuel filter assembly 16a. Thus, any back flow of fuel remaining the filter portion 14a of the fuel passage 14 during detachment of the fuel filter assembly 16a will be blocked by the closed check ball valve 30. Further, when the fuel filter assembly 16a is detached from the fuel system 9, the check ball valve 30 will block the fuel system 9 from dirt and debris in the environment, and reduce the draining of the fuel within the delivery portion 14b of the fuel passage 14 from the fuel system 9.

After the fuel filter assembly 16a is detached from the fuel system 9, the used fuel filter 18 can be detached from the housing 17 and replace with a fresh fuel filter 18, also including the valve engaging member 31. During assembly of the fuel filer 18, the valve engaging member 31 is preferably integrally molded with the cylindrical core 22 out of the plastic material. After the fresh fuel filter 18 is attached and secured to the housing 17 by means known in the art, the fuel filter assembly 16a may be attached and secured to the filter head 24. Because the present invention illustrates the fuel filter assembly 16a being threadibly secured to the filter head 24, the fuel filter assembly 16a will be rotated with respect to filter head 24 until the fuel filter assembly 16a is securely attached. As the fuel filter assembly 16a is rotated, the valve engaging member 31 that has been integrally molded with the cylindrical core 22 out of the plastic material, will come in contact with the ball valve member 32 of the valve 30. The punch 41 of the valve engaging member 31 is shaped to fit within the valve bore 34 and lift the ball valve member 32 off the valve seat 36. The pressure of the fuel filter assembly 16a being attached and secured to the filter head 24 is sufficient to overcome the bias of the spring 33. When the ball valve member 32 is off the valve seat 36, the center passage 20 is in communication with the delivery portion 14b of the fuel passage 14. Thus, when the fuel filter assembly 16a is attached to the fuel system 9, fuel can flow freely through the filter portion 14a of the fuel passage 14.

When the operator re-activates the engine 10, the fuel transfer pump 13 will being pumping fuel from the fuel tank 12 to the first fuel filter assembly 16a and the second fuel filter assembly 16b via the delivery portion 14b of the filter passage 14. Because the punch 41 has lifted the ball valve member 32 off the valve seat 36, the fuel passage 14 is open The fuel will flow from the delivery portion 14b to the outer peripheral passage 25 via the inlet 19. As the fuel flows through the filter element 21, particulates and water will be separated from the fuel. Due to its specific gravity, the water will collect below the fuel filter 18 in the cup-shaped portion of the housing 17. The water will preferably be periodically drained from the fuel filer assembly 16a via the water drain valve 26 in order to avoid the water from reaching levels at which it re-mixes with the fuel passing through the fuel filter 18. The fuel will then flow to the center passage 20 via the plurality of holes 23. Because the valve 30 is open, the fuel will flow to the delivery portion 14b via the outlet 29.

The fuel will be delivered to the second fuel filter assembly 16b through which it flows in a similar manner as it flowed through the first filter assembly 16a. However, fuel will be pulled through one of the fuel filter assemblies 16a or 16b, and fuel will be pushed with pressure through the other fuel filter assembly 16a or 16b. The fuel flows through the second fuel filter assembly 16b via the outer peripheral passage 25, the center passage 20, the valve bore 34, and past the open check ball valve 30. The cleaned fuel will be delivered to the fuel injector 15 for injection into the engine 10. The fuel that is not injected into the engine 10 will be delivered from the fuel injector 15 to the fuel tank 12 via the return portion 14c of the fuel passage 14. The returned fuel can be re-circulated through the fuel system 9.

The present invention is advantageous because it blocks the fuel system 9, specifically the delivery portion 14b of fuel passage 14, from the environment when the fuel filter assembly 16a is detached, and opens the fuel passage 14 to the fuel filter assembly 16a when the fuel filter assembly 16a is attached. There are multiple advantages to blocking the fuel system 9 from the environment when the fuel filter assembly 16a is detached form the fuel system 9. First, the check ball valve 30 will prevent fuel from flowing from the fuel system 9 via the center extension 28 and onto the ground when the fuel filter 18 is being changed. Because fuel will not drain from the delivery portion 14b of the fuel passage 14, the entire fuel system 9 may not need to be re-primed after changing the fuel filter 18. Rather, only the fuel filter assembly 16a including the fresh fuel filter 18 will need to be primed. Moreover, if fuel is drained from the fuel system 9, air may replace the drained fuel. Thus, preventing the draining of fuel from the fuel system 9 may decrease the risk of supplying air, rather than fuel, to the fuel injector 15 and the fuel filter assemblies 16a and 16b, and thereby, possibly damaging the fuel injector 15 and the fuel filter assemblies 16a and 16b.

In addition, detaching the fuel filter assembly 16a from the fuel system 9 may cause a back flow of fuel from the filter portion 14a into the delivery portion 14b of the fuel passage 14. Because the ball valve member 32 will move in contact with the valve seat 36 when the tapered punch 41 is pulled away from the valve member 32, the closed check ball valve 30 will prevent the back flow of the fuel from the filter portion 14a. Further, the closed check ball valve 30 will prevent debris and dirt from entering the system through the center extension 28 of the filter head 24. Dirt and debris circulated through the fuel system 9 could damage the fuel system 9. For instance, the debris may clog the fuel transfer pump 13.

Besides the present invention being advantageous when fuel is not being circulated through the fuel system 9, such as when the fuel filter 18 is being changed, the present invention is advantageous if an operator attempts to operate the vehicle or work machine without a fuel filter. For instance, if an operator in the field removes a clogged fuel filter and re-attaches the housing 17 to the fuel system 9 without a fresh fuel filter, the check ball valve 30 will remain closed.

The closed check ball valve 30 will block the flow of fuel through the filter portion 14b of the fuel passage 14, preventing the operation of the vehicle or work machine. Thus, fuel that has not been cleaned by the fuel filters 16a and 16b will not be supplied to the fuel injector 15, and thereby reducing the likelihood of damage to the fuel system, including the fuel injector 15.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A fuel filter assembly comprising:
a housing;
a fuel filter positioned within the housing;
a fuel passage being defined by at least one of the fuel filter and the housing; and
at least one valve engaging member being positioned, at least in part, within the fuel passage.

2. The fuel filter assembly of claim 1 wherein the housing includes a center line that intersects the valve engaging member.

3. The fuel filter assembly of claim 1 wherein the fuel filter includes a cylindrical core; and
the valve engaging member being attached to the cylindrical core.

4. The fuel filter assembly of claim 3 wherein the valve engaging member and the cylindrical core being integrally molded from a plastic material.

5. The fuel filter assembly of claim 1 including a water drain.

6. The fuel filter assembly of claim 1 wherein the valve engaging member includes a tapered punch and a ring defining a portion of a fuel passage.

7. The fuel filter assembly of claim 6 wherein the valve engaging member separates an upstream portion of the fuel passage from a downstream portion of the fuel passage.

8. The fuel filter assembly of claim 7 wherein a centerline of the housing intersects the valve engaging member;
the valve engaging member and the cylindrical core being integrally molded from a plastic material; and
the fuel filter assembly includes a water drain.

9. A fuel system comprising:
a fuel passage including a filter portion and a delivery portion;
a detachable fuel filter assembly defining the filter portion of the fuel passage;
a valve being moveable between a closed position and an open position and being at least partially positioned within the delivery portion of the fuel passage;
a valve engaging member being attached to the fuel filter assembly; and
when the fuel filter assembly is attached to the fuel system, the valve engaging member is in contact with the valve; and when the fuel filter assembly is detached from the fuel system, the valve engaging member is out of contact with the valve.

10. The fuel system of claim 9 wherein the valve is a check valve.

11. The fuel system of claim 10 wherein the valve is biased to a closed position by a spring.

12. The fuel system of claim 9 wherein the fuel filter assembly includes a water drain.

13. The fuel system of claim 9 wherein the valve engaging member is at least partially positioned within the filter portion of the fuel passage.

14. The fuel system of claim 13 wherein the valve engaging member separates an upper portion and a lower portion of the filter portion of the fuel passage.

15. The fuel system of claim 14 wherein the fuel filter assembly includes a housing; and
the valve engaging member being intersected by a centerline of the housing.

16. The fuel system of claim 15 wherein the fuel filter assembly includes a cylindrical core; and
the cylindrical core and the valve engaging member being integrally molded from a plastic material.

17. The fuel system of claim 16 wherein the valve being a check valve biased to a closed position by a spring; and
the fuel filter assembly includes a water drain.

18. A method of changing a fuel filter within a fuel system comprising the steps of:
closing a valve positioned within the fuel system, at least in part, by detaching a fuel filter assembly from the fuel system; and
opening the valve positioned within the fuel system, at least in part, by attaching the fuel filter assembly to the fuel system.

19. The method of claim 18 wherein the step of opening includes a step of contacting the valve with a valve engaging member attached to the fuel filter assembly.

20. The method of claim 18 wherein the step of closing includes a step of moving the valve engaging member attached to the fuel filter assembly out of contact from the valve.
